(19) United States
(12) Patent Application Publication
(10) Pub. No.: US 2022/0069449 A1
(43) Pub. Date: Mar. 3, 2022

(54) UNMANNED AERIAL VEHICLE ANTENNA CONFIGURATIONS

(71) Applicant: Apple Inc., Cupertino, CA (US)

(72) Inventors: Feng Xue, Redwood City, CA (US); Jingwen Bai, San Jose, CA (US); Jose Camacho Perez, Guadalajara Jalisco, JAL (MX); Debabani Choudhury, Thousand Oaks, CA (US); Timo Huusari, Munich, Bavaria (DE); Bradley Alan Jackson, Hillsboro, OR (US); Yeonsoo KO, Portland, OR (US); Seong-Youp Suh, San Jose, CA (US); Daniel Tong, Beaverton, OR (US); Shu-Ping Yeh, Campbell, CA (US)

(21) Appl. No.: 17/418,734

(22) PCT Filed: Dec. 28, 2018
(86) PCT No.: PCT/US2018/067855

§ 371 Date: Jun. 25, 2021

(51) Int. Cl. H01Q 1/28; H01Q 21/20

(52) U.S. Cl. CPC H01Q 1/28; H01Q 21/20

(57) ABSTRACT

A unmanned aerial vehicle can include a modem comprising a first antenna port and a second antenna port, an omnidirectional antenna connected to the first antenna port, and antennas configured to generate a directional transmission pattern connected to the second antenna port, the antennas including (a) an array of omni-directional antennas and (b) multiple directional antennas

### TECHNICAL FIELD

Aspects regard wireless communication systems. Some aspects regard antenna systems for unmanned aerial vehicles (UAVs). In some aspects, a UAV includes multiple antennas, such as multiple directional antennas, multiple omnidirectional antennas, or one or more directional antennas and one or more omnidirectional antennas.

### BACKGROUND

Current remote control (RC) UAVs are controlled with a point-to-point radio link in line-of-sight range. This reduces, in many examples, the fly area to within about a few hundred meters of the controller. This limits the use cases of RC UAVs as the operation range is limited. In order to expand the use, a non-line-of-sight control mechanism can help. Omni-directional antennas currently present on UAVs do not work well in the sky as the UAVs are subject to signals from multiple base-stations causing strong interference.

In present UAV systems, an antenna, usually an omni-directional antenna, is attached on the body of the UAV. The body of the UAV is often made of lossy carbon fiber, which causes degradation of antenna performance and even worse, antenna performance cannot be controlled and predicted due to variations of UAVs

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document.

FIG. 1 illustrates, by way of example, a diagram of an aspect of a UAV with a configurable antenna array in an antenna module.

FIG. 2 illustrates, by way of example, an exploded diagram of a portion of the UAV of FIG. 1.

FIGS. 3 and 4 illustrate results of simulations that do not include the UAV body.

FIG. 5 illustrates, by way of example, a diagram of an aspect of a simulation of the antenna radiation patterns with the UAV body as part of the simulation.

FIGS. 6, 7, and 8 illustrate, by way of example, diagrams of respective aspects of systems for communication between a UAV 100 and a communications network.

FIG. 9 illustrates, by way of example, a diagram of an aspect of a method for communication between a UAV and a communications network.

FIG. 10 illustrates, by way of example, a diagram of an aspect of a system that illustrates this problem.

FIGS. 11 and 12 illustrate, by way of example, respective diagrams of aspects of systems and for UAV communication over a communications network.

FIG. 13 illustrates, by way of example, a diagram of an aspect of a method for UAV communication in a communications network.

FIG. 14 illustrates a block diagram of an example machine upon which any one or more of the techniques (e.g., methodologies) discussed herein may perform.

### DETAILED DESCRIPTION

A drone is a UAV that can benefit from connecting, communicating, or sensing under dynamic movements in the sky. The current drones with an omni-directional antenna are limited in their usage. For example, in the sky, UAVs are subjected to signals from base stations than a ground user equipment (UE). The base stations emit unwanted interfering signals to the UAVs with the omni-directional pattern, which degrades the communication performance significantly. However, the omni-directional pattern is preferred while the UAV is near the ground.

With the current omni-directional antenna in the drone, it is very challenging to mitigate the interfering signals for both uplink (UL) and downlink (DL) while the UAV is in the air. Aspects include a dynamic pattern reconfigurable directional antenna that can increase a signal to noise ratio (SNR), such as by redirecting the main beam to the base stations while minimizing the pattern and gain toward the direction of interference. On the ground, or other usage, an antenna of aspects can be reconfigured or switched to an omni-directional antenna dynamically. Significant system performance gain can be observed based on third generation partnership project (3GPP) study drone work item (3GPP TR3.36.777) for 4G and 5G.

As previously discussed in the background, an antenna placed or attached on the body of a UAV made of lossy carbon fiber causes degradation of antenna performance and even worse, antenna performance cannot be controlled and predicted due to variations of industrial drone form factor. Aspects can help overcome these issues of current UAVs.

As discussed in the background, the current point-to-point radio links on UAVs restrict the travel distance of the UAVs in many situations. Aspects can help overcome this restriction of the point-to-point radio links. Aspects can use, for example, a cellular or other communication network, which is readily available and widely distributed. Aspects can include a mechanism to focus on one base station at a time. Some aspects can include a reconfigurable, dynamic pattern antenna.

An antenna array, with the proper control circuitry, can provide a configurable, dynamic pattern. The antenna array can offer either an omni-directional pattern or a directed antenna pattern. The directed pattern can have various angular coverages. The antenna array can enable single or multi-beams simultaneously. The antenna array can be coupled to a switching component and control circuitry so that the antenna array can have angular coverage from 60° to full 360°, depending on the application.

In some aspects, the UAV on the ground can benefit from an omni-directional pattern. To achieve this, all, or a subset of, antenna elements or the array can be powered on to cover the 360° horizontal plane. In the sky, to mitigate interference to and from multiple base stations, only one, or a couple of antenna elements of the array, can be activated to minimize an array beam pattern to incoming interference and to cover the required angular coverage simultaneously. Field tests and simulations have shown that base station interference is increased in the air as compared to on the ground.

Aspects include a new integrated antenna module concept for drone system which allow controlled antenna performance among various drone form factor (FF). The antenna module can include a ground plane with a circuit board that enables collocation of multiple antennas utilizing the ground plane and circuit board for antenna designs. For example, some aspects can include a monopole or planar inverted-F antenna (PIFA), patch antenna, or Substrate Integrated Waveguide (SIW) antenna, or the like. The antenna(s) can be integrated in the antenna module. Optimal designs can consider the antenna-to-antenna coupling of antennas in the antenna module, form factor of the antenna module (for aerodynamics and flight stability), weight, or the like. For UAVs with cameras, the antenna module can provide camera connectivity.

Aspects include an antenna solution for a UAV system with dynamic pattern reconfigurability. The aspects include many applications including non-visual line of sight UAV communication based on cellular network. The antenna can create single and/or multi-beams simultaneously using a switching mechanism and control technique so that the UAV antenna can cover an angular coverage from 60° (or less) to a full 360°, depending on the application. Aspects can scan a main beam up to 30° or more by combining two antennas. FIGS. illustrating simulation results are provided elsewhere herein.

Aspects can include an antenna module that integrates radio circuitry (e.g., multi-protocol radio circuitry) and antennas to enable versatile communications for UAVs even in non-visual line of sight conditions. The module can be used in different UAV form-factors without re-design. The module can also include a feature for integration of video cameras.

An advantage of aspects can include enhancing communication performance of UL and DL by mitigating interference and increase flexibility of UAV usage and application by providing dynamic configurability, a modular antenna device that can be used with many UAVs without re-design, and antenna configurations that allow communication using a variety of protocols, such as long-term evolution (LTE), wireless fidelity (WiFi), coexistence of an antenna and camera on/in the same module, or the like.

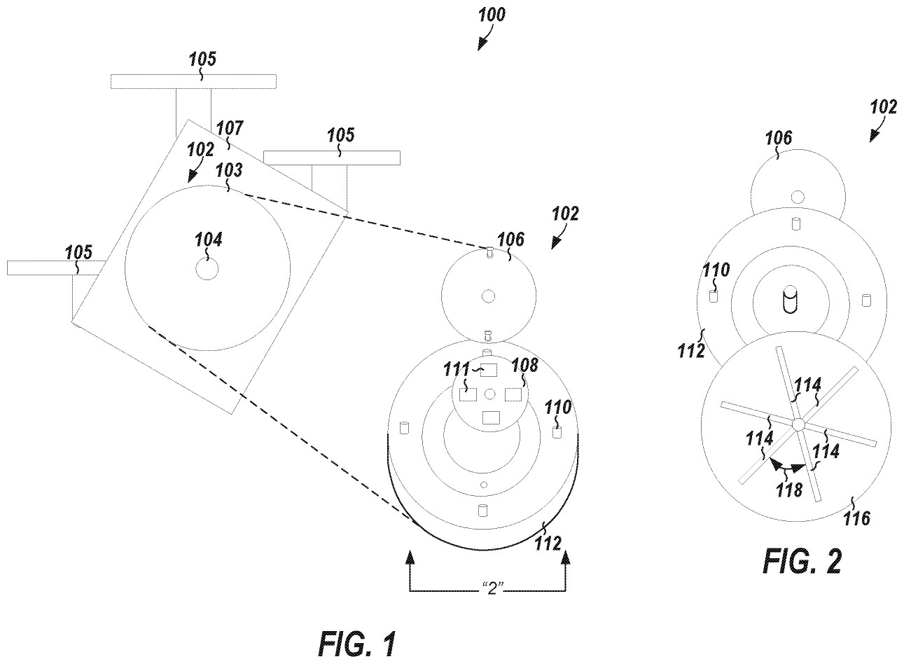

FIGS. 1 and 2 illustrate, by way of example, a diagram of an aspect of a UAV 100 with a configurable antenna array 114 in an antenna module 102. The UAV 100 as illustrated includes the antenna module 102 and propellers 105 attached to a body 107.

The antenna module 102 includes a radome cover 103, a circuit board cover 106, a circuit board 108 with circuitry 111, a body attachment feature 110, a radome 112, antennas 114, and a ground plane 116. The propellers 105 rotate to provide lift to the UAV 100 to allow the UAV 100 to leave the ground and enter airspace. The propellers 105 can be controlled by the circuitry on the circuit board 108 or other circuitry in the body 107 of the UAV 100.

The circuit board cover 106 can provide physical protection to the circuit board 108. The circuit board cover 106 can provide interference protection to the circuitry on the circuit board 108. The circuit board cover 106 can be attached to the radome 112.

The circuit board 108 can include the UAV control circuitry radio circuitry, camera control circuitry, or other UAV circuitry 111. The UAV circuitry 111 can include one or more electrical or electronic components configured to perform operations of the UAV 100. The electrical or electronic components can be configured as processing circuitry, such as can include a processor, central processing unit (CPU), application specific integrated circuit (ASIC), field programmable gate array (FPGA), graphics processing unit (GPU), or the like. The electric or electronic components can include one or more transistors, resistors, capacitors, inductors, diodes, regulators, converters (analog to digital or digital to analog converters), oscillators, de/modulators, switches, logic gates (e.g., AND, OR, XOR, negate, buffer, or the like), multiplexers, inverters, amplifiers, or the like. The electric or electronic components can be configured as control circuitry for the antennas 114 (see FIG. 2), propellers 105, camera (not shown), or other operations of the UAV 100.

The radome 112 can include male or female attachment features 110 configured to attach the antenna module 102 to the body 107 of the UAV 100. The radome 112 can be made of a material or materials that do not interfere with signals transmitted by the antennas 114. The radome 112 can include a radome cover 103 that protects the antennas 114 from the surrounding environment. The radome 112 can be water resistant or waterproof, such as to help prevent the ingress of moisture.

The antennas 114 are configured in an array. The antennas 114 are electrically coupled to the control circuitry of the circuit board 108. The control circuitry can select one or more antennas 114 to transmit one or more directional or omnidirectional signals. The antennas 114 can include a monopole, FIFA, patch antenna, or SIW antenna, or the like. The antennas 114 can be situated about the ground plane 116 with an angular separation 118 between directly adjacent antennas 114. The angular separation 118 in FIG. 2 is about 60 degrees, since there are six antennas 114. However, the antennas 114 can include two or more antennas 114, such as three, four, five, or more than six antennas. The antennas 114 can be situated with about an equal (e.g., uniform) angular separation 118 between directly adjacent antennas.

The antenna module 102 of aspects can help enable communications in no-visual line of sight scenarios, such as with the help of a cellular or other communication system. The antennas 114 can include a directional switched array. In some aspects, the antennas can include several monopole Yagi-Uda antenna elements. In order to show the feasibility of the invention, a simple, non-optimized proof of concept was simulated.

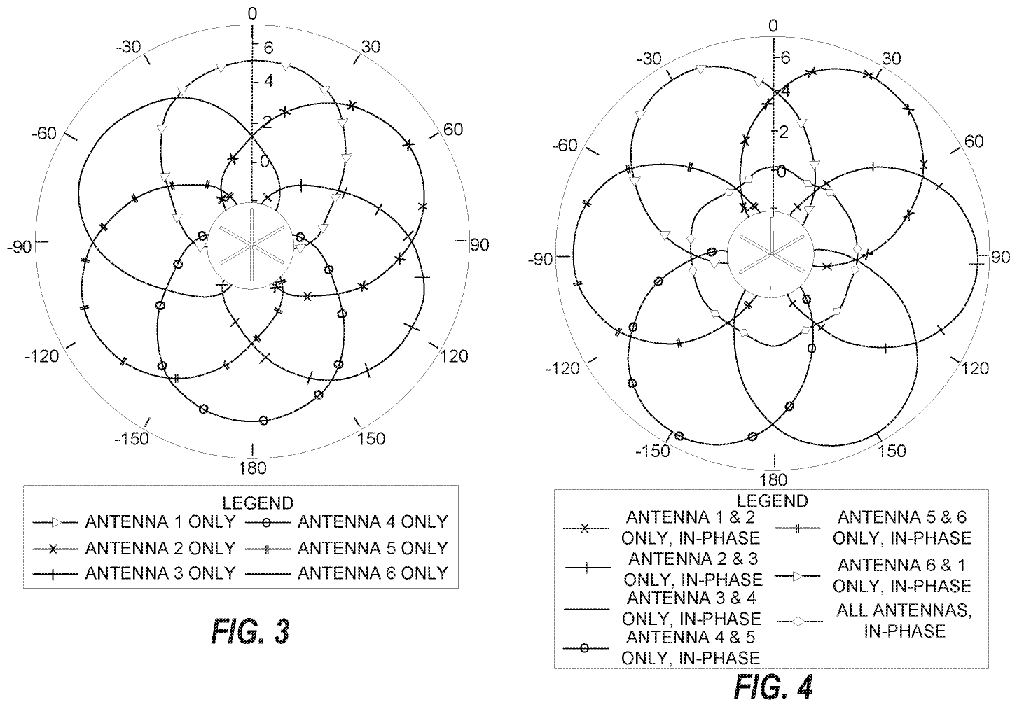

FIGS. 3-5 illustrate, by way of example, respective graphs of transmission patterns produced by the antennas 114. The graph of FIG. 3 illustrates simulation results of the array installed in a simplified 3D model of an Intel Aero Drone for various antenna configurations, In the simulation of FIG. 3, six planar monopole Yagi-Uda antenna elements are directed every 60° around a central axis of the UAV (azimuth plane of the UAV). The antennas 114 can be connected to radio circuitry individually. The antennas 114 can operate in-phase to deliver flexible beam-steering control.

FIGS. 3 and 4 illustrate results of simulations that do not include the UAV body. FIG. 3 illustrates antenna radiation patterns for individual antennas. FIG. 4 illustrates antenna radiation patterns for two, in-phase, directly adjacent antennas transmitting simultaneously. As can be seen, the pattern can be controlled by switching individual antennas or driving multiple of them simultaneously. Directivity of the simulated antennas 114 may not be optimal and can be improved by adjusting the number and separation of directors and reflector of each antenna 114. Yet, the graphs of FIGS. 3 and 4 suggest the feasibility of dynamic pattern switching even without optimized antenna elements.

FIG. 3 illustrates the simulation results of an antenna beam selection mode with only one antenna powered on and driven at a time. Each line shows the directive radiation pattern of an antenna with a main beam direction aligned with the antenna direction. FIG. 4 illustrates the capability of beam steering by using two or more antennas powered on and driven simultaneously. In FIG. 4, the radiation pattern is ±30° beam steering from the directions of the radiations pattern of the antennas individually, as shown in FIG. 3. This directionality of combined antennas 114 can enhance a gain between the radiation patterns in FIG. 3. When all the antennas 114 are powered on and driven, the directional pattern is reconfigured to an omni-directional pattern depicted in FIG. 4 with diamond markings.

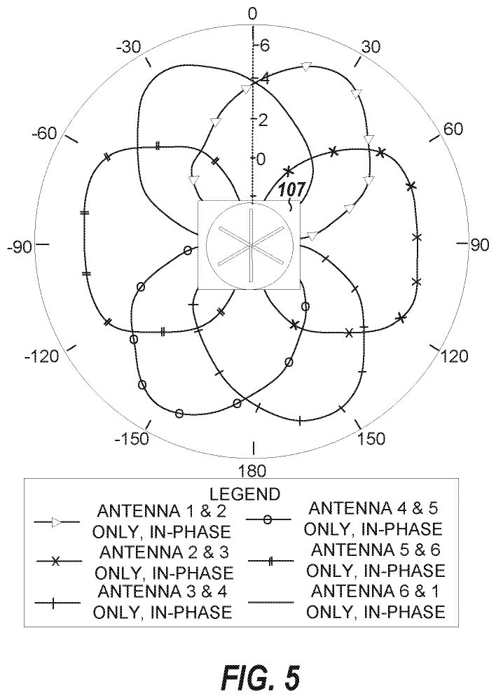

FIG. 5 illustrates, by way of example, a diagram of an aspect of a simulation of the antenna radiation patterns with the UAV body as part of the simulation. FIG. 5 shows the simplicity of integration on a UAV without antenna re-design. Despite the impact of the UAV body 107, the antennas 114 are capable of beam steering every 60° in azimuth as illustrated in FIG. 5. This is possible thanks to the power of the dynamic pattern reconfigurability of aspects. All it takes to reduce an impact of the UAV body 107, and maintain beam steering capabilities, is antenna directionality.

The antenna module 102 can be aerodynamically feasible. In the case of UAV antennas, one of the key impact is the effect of the antenna 114 on the flight capabilities of the UAV. To test the impact of the proposed antenna module 102, a dummy antenna module of radius=17 cm and height=3 cm (enough to accommodate antennas like those of FIG. 2) was installed on an Intel Aero drone. The drone was flown and maneuvered, thus proving the feasibility of including the antenna module 102 with the drone to enhance communications capabilities. The tests showed that there was little to no impact to the controllability of the flight suggesting minimal aerodynamic impact from the dummy module.

It will be appreciated that the antennas 114 provide directionality without the need for any phase shifters. This helps reduce the complexity and weight of the circuitry 111 on the circuit board 108.

Wireless carriers are under pressure to support UAVs on their networks. 3GPP has an on-going study item on supporting aerial vehicles. Study and measurements have shown that UAVs with omni-directional antennas in the air will cause excessive interference to the ground stations and suffer interference from many BS's when omni-directional antennas are used.

Directional TX/RX (transmissions and receptions) will greatly mitigate the interference issues in both UL and DL. The directional transmit and receive can be achieved in several ways. One way is to use directional antennas which have directional pattern towards a certain angular span. One such antenna can be attached to the UAV. The antenna can then be physically steered to a desired direction, such as by a motor. In some alternative aspects can attach multiple directional antennas and turn on one for TX/RX one at a time. Another way is to use multiple antennas to form a beam (e.g. antenna array). In this case, the array is a virtual directional antenna.

As the UAV can move fast in the air, one can need to steer the beam towards a desired BS adaptively. In some aspects, one might use both omni-directional and directional antennas on the same UAV.

These directional TX/RX use cases can create several issues that can be addressed with aspects. The aspects can address these issues with minimal changes to an existing communications network (e.g., cellular or another wireless communications network). These issues can include one or more of: 1) how to make sure that the UAV UE will connect to a “correct” BS. This is an issue because, with a directional antenna pattern, it is challenging for the UAV to listen to all possible BSs within range and choose the best one to which to connect. The signal strength from a cell not in the current main beam can suppressed by tens of decibels (dBs) in a typical measurement. If that BS is used and the antenna direction aligned with the BS, the quality will be significantly improved. 2) how to make sure the measurement report (e.g., neighboring cell qualities such as a reference signal received power (RSRP)/reference signal received quality (RSRQ), channel quality indicator (CQI), or the like) still works without changing the current design? 3) how to enable handover when needed?

UAVs were not in consideration when cellular systems were designed. There have not been clear answers to the problems mentioned above to support smooth directional TX/RX. When multiple omni-directional antennas are used on a drone, UL or DL MIMO provides a limited way to support beamforming in the UAV by using a codebook to form beams. The existing MIMO support has several drawbacks: 1) When directional antennas are used, the antennas cannot listen fairly to all directions, and standard MIMO codebook may not work for these special antennas. 2) In existing products/standards, MIMO is not well supported to its full extent. For example, UL MIMO is not well-supported now. Even if 2TX or 4TX is supported, the codebook is too sparse to cover the full angular domain well, which can be important for the UAV case. In the UAV case, the number of antennas can be larger than the number of antenna ports supported by the modem, the extra antennas can be used for forming virtual directional antennas such as in the array case.

In aspects, a UAV can consult a database including data that indicates which BSs are good candidates to monitor for connections. The database can be organized by geographical location, such that a UAV can look up their location to determine a location of a BS to which to communicate. In some aspects, such as when only directional antennas are used or present, every antenna can be activated to monitor the signal quality, separately, as part of the end report on cell/channel state information (CSI) qualities. In some aspects, such as when only omni-directional antennas are present or used, one antenna can be used for actively measuring, but an array pattern (a pattern formed by all the antennas) and directions of candidate cells can be combined in the end report on cell/CSI. In some aspects, such as when omni-directional and directional antennas are present and used, the omni-directional antenna can be used for quality measurement based on (e.g., reference signal), while the end report can consider the impact of a directional pattern. In some aspects, an actual cell selection and channels (e.g., control channel/data channel, or the like) can be formed along with a directional beam from one directional antenna or a beam foiled by multiple antennas.

UAV TX/RX using a directional pattern (e.g., from a directional antenna or a virtual beam from an array) can help support UAVs on a communications network. Aspects provide ways to support such TX/RX without changing the standard interfaces. This can be used by communications carriers or UAV makers to support UAVs on a communications network with low impact on the UAV and the communications network. Some aspects can include one of three antenna arrangements that can help implement directional TX/RX for UAVs. Some aspects can include multiple directional antennas on a UAV, with each being fixed to the drone frame. Some other aspects can include multiple omni-directional antennas. Yet other aspects can include at least one omni and at least one directional antenna.

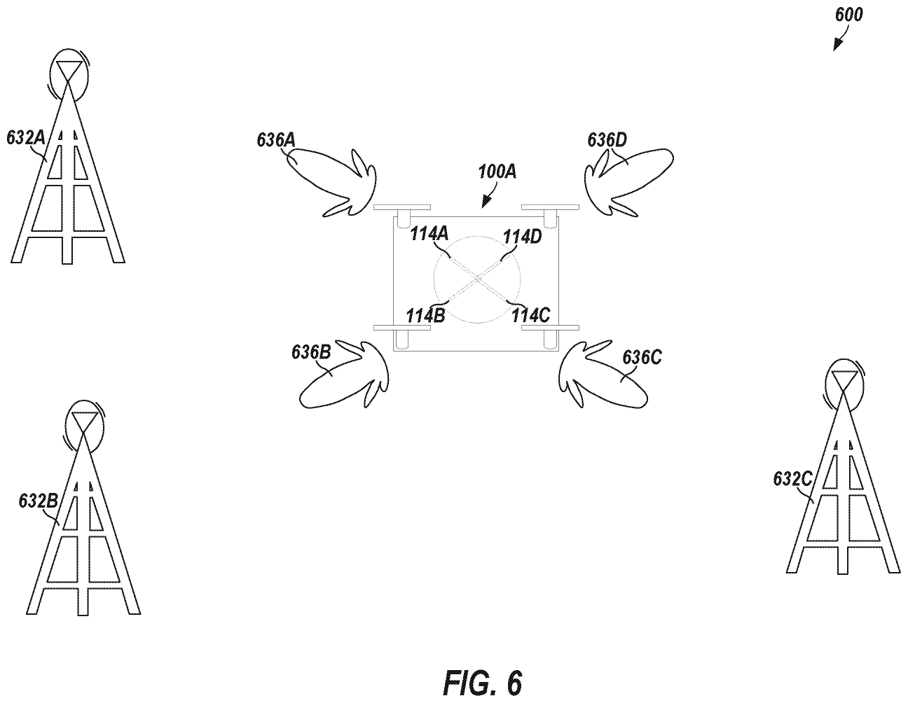

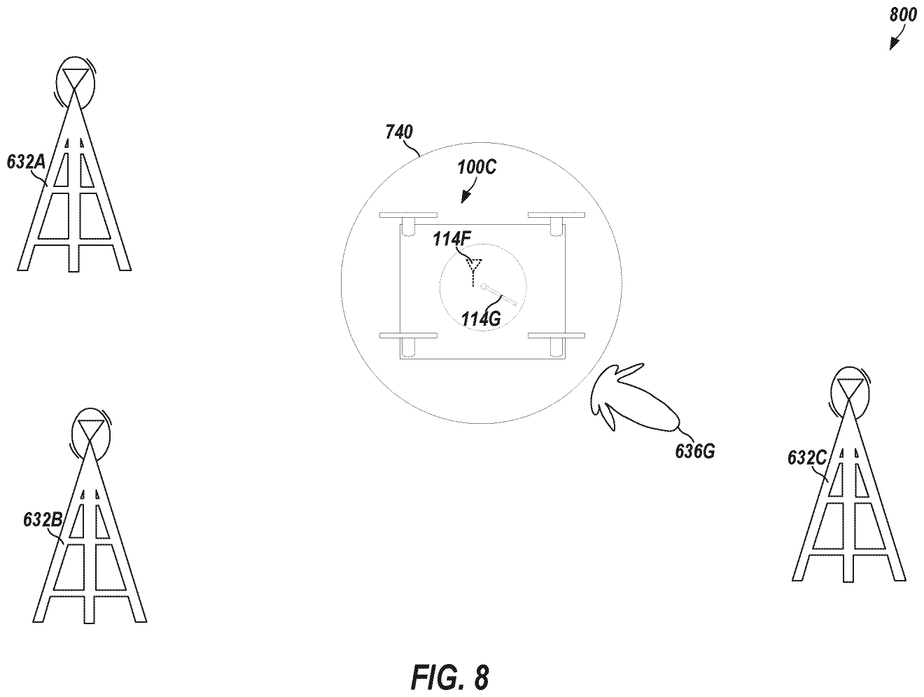

FIGS. 6, 7, and 8 illustrate, by way of example, diagrams of respective aspects of systems 600, 700, 800 for communication between a UAV 100 and a communications network. The communications networks of FIGS. 6-8 comprise a plurality of base stations 632A, 632B, 632C through which the UAV 100 can communicate to a user interface, server, database, or other computer device. In some aspects the communications network includes circuitry configured to implement a protocol consistent with Institute of Electrical and Electronic Engineers (IEEE) 802.11 family of standards or other communications standard. Some common communication protocols are known, colloquially, as LTE, 4G, 5G, WiFi, WiMax or the like. The base stations 632A-632C can thus include an enhanced. Node B (eNodeB) or Access Point (AP).

The UAV 100A of FIG. 6 as illustrated includes a plurality of directional antennas 114A, 114B, 114C, 114D. Each of the antennas 114A-114D has a corresponding transmission pattern 636A, 6369, 636C, and 636D, respectively.

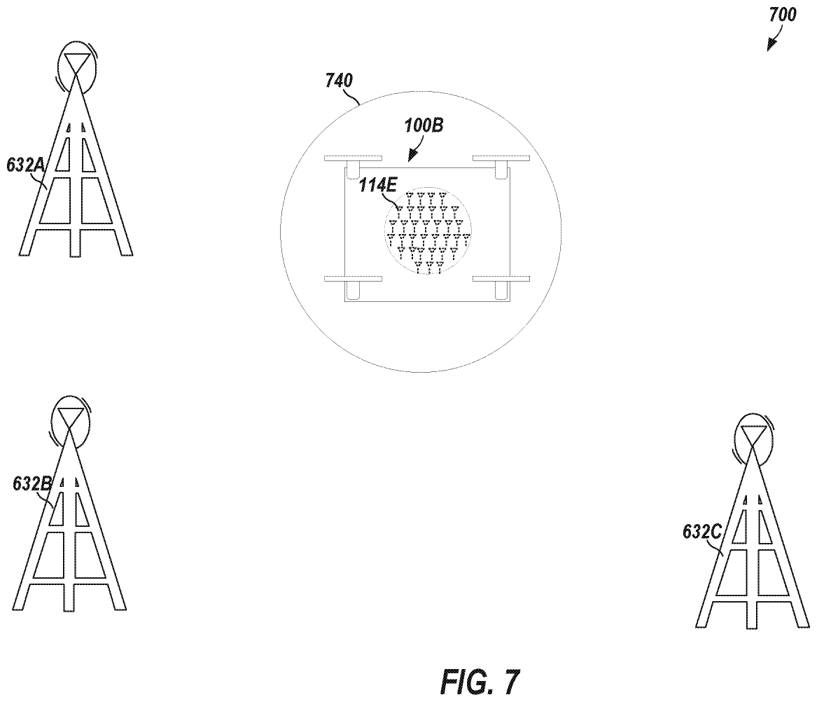

The UAV 100B of FIG. 7 as illustrated includes an antenna array 114E that includes plurality of omnidirectional antennas. Each of the antennas or the array 114E has a transmission pattern 740. However, by controlling a phase, amplitude, or timing of the transmission of antennas of the array 114E, a transmission from the array 114E can be steered in generally any horizontal direction from the UAV 100B.

The UAV 100C as illustrated includes an omnidirectional antenna 114F and a directional antenna 114G. The direction to which the directional antenna 114G points can be controlled by a motor of the UAV 100C. The transmission pattern 740 corresponds to the omnidirectional antenna 114F and the transmission pattern 636G corresponds to the directional antenna 114G.

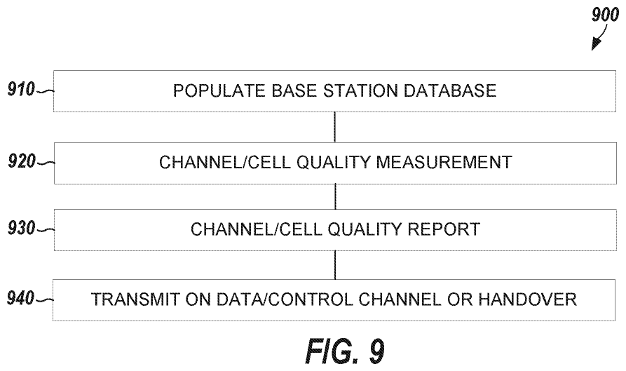

FIG. 9 illustrates, by way of example, a diagram of an aspect of a method 900 for communication between a UAV and a communications network. The method 900 as illustrated includes populating a base station database, at operation 910; performing a channel or cell quality measurement, at operation 920; providing a channel or cell quality report to one or more base stations, at operation 930; and transmitting on a data or control channel or performing a handover based on the report, at operation 940.

The base station database can include data correlating a geographical position of the UAV 100 to one or more base stations 632 with which to communicate. The base station database can include data indicating a position of the base station 632. The position of the base station 632 can be used by the control circuitry of the UAV 100 to determine a direction to which to direct a transmission from either (1) multiple omni-directional antennas if the UAV 100 includes an omni-directional antenna array or (2) one or more directional antennas.

Based on measurement and analysis, a channel situation in the air is more stationary compared to the ground channels. This is due, at least in part, that there is almost no obstacle or multipath in the air. At a particular location, one can predict with sufficient accuracy, which set of cells are likely to have sufficient signal strengths. Based on this, one can build up a location-based data base, where each location is associated with a set of one or more cells as potential serving cells for UAVs near that location. A cell is sometimes called a base station and vice versa. The operation 910 can be preloaded to the UAV 100 or communicated to the UAV 100 over a data link, such as from a base station 632 or another device.

Operation 920, when the UAV 100 includes multiple directional antennas and no omni-directional antennas, can include the UAV 100 monitoring, through antennas 114, channel quality by looking at the reference signals such as Cell Specific Reference Signals (CRS), or the like. Operation 920, when the UAV 100 includes multiple omni-directional antennas and no directional antennas, can include one antenna (single or cross polarization) for monitoring its channel quality by looking at the well-known reference signals, such as CR, or the like. Operation 920, when the UAV 100 includes one or more directional antennas and one or more omni-directional antennas, can include monitoring, by the omni-directional antenna ANT0 (single or cross polarization) channel quality by looking at a reference signal, such as CRS or the like

The operation 920 can include the UAV 100 calculating a cell quality for each identifiable cell based on the standard (e.g., the neighboring cell's RSRP/RSRQ's). In aspects, candidate cells from the operation 910 can be given higher priority when resources are limited.

Operation 930, when the UAV 100 includes multiple directional antennas and no omni-directional antennas, can include aggregating, at the control circuitry, information from each antenna. The operation 930 can combine the information together to form a final report according to the standard.

Operation 930, when the UAV 100 includes multiple omni-directional antennas, can include adjusting the information received at operation 920. The information from a measurement antenna (ANT0) can be re-adjusted. based on an array pattern according to the direction of the corresponding cell. The array pattern is the aggregated beam pattern the array uses to send/receive towards the particular cell of interests, which could be specifically designed or realized based on certain beamforming technique such as discrete Fourier transform (DFT) code book. In some aspects, a cells channel strength can be calculated as follows:

CellStrength(cell)=CellStrength_FromANT0(cell)+beamPatternGainWhenTarget(cell).

Where CellStrength_FromANT0(cell) corresponds to strength of a signal from a cell to an antenna corresponding to ANT0 and beamPatternGainWhenTarget(cell) corresponds to a gain achieved by the antenna(s) when configured to transmit to the cell.

The operation 930, when the UAV 100 includes one or more omni-directional antennas and one or more directional antennas, can include denoting the information from antenna ANT0 for cell E as Strength_ANT0(E). The strength can be re-adjusted based on the antenna pattern of the directional antenna(s). The pattern of the directional antenna can be pre-calculated or calibrated beforehand. The calculated signal strength information can be denoted as Strength(E). To determine the correct antenna gain adjustment for Strength(E), the calculation can account for whether the directional antenna will be tilted (either through a special tool like servo or via a movement of the UAV 100 itself) to a certain direction at the moment of expected TX/RX. For example, the antenna may take 0.1 seconds to rotate 10 degrees. In a mathematical format this can be represented as follows: Strength(E)=Strength_ANT0(E)+directionalAntPatternGainForCell(E). The information from both Strength(E) and Strength_ANT0(E) can be included in the final report to the serving cell (e.g., neighboring cells' RSRQ/RSRP's).

Where Strength(E) corresponds to to a total strength of a signal from a cell to the antennas of UAV, Strength_ANT0(E) corresponds to strength of a signal from a cell to an antenna corresponding to ANT0 and directionalAntPatternGainForCell(E) corresponds to a gain achieved by the directional antenna(s) when configured to transmit to the cell.

The operation 930 can include providing the report to its serving cell. A particular example is the report of its neighboring cells' qualities in terms of RSRQ/RSRP.

The operation 940 can include providing transmissions for control/data channels, or cell switching. The active link between the UAV 100 and its serving cell, when the UAV 100 includes multiple directional antennas and no omni-directional antenna, can be implemented by a directional antenna which is pointing towards the base station (or the one with the highest link quality). The active link between the UAV 100 and its serving cell, when the UAV 100 includes multiple omni-directional antennas and no directional antennas, can be implemented on top of the beam based on which the report was derived, and which achieves the best channel quality. The active link between the UAV 100 and its serving cell, when the UAV 100 includes one or more omni-directional antennas and one or more directional antennas, can be implemented by a directional antenna which is pointing towards the base station (or the one with the highest link quality).

The transmission(s) of operation 940 can include both TX and RX channels. The link adaptation, such as modulation and coding scheme (MCS)/rank indicator (RI)/channel quality indicator (CQI) can be determined based on this particular directional antenna.

When cell handover is triggered at operation 940 (e.g., based on standard procedures from the serving cell), the normal procedure will be followed and the corresponding directional antenna(s) that are directionally closest to pointing towards the base station can be put to active TX/RX mode for supporting the new serving cell. In some aspects, the operation 940 can include adjusting a beam direction of a transmission from an antenna array or adjusting a tilt of a directional antenna.

The method 900 provides a set of compensation methods to form a ‘correct’ measurement report at the UAV 100. The normal operations over the existing standard interfaces can be maintained while directional TX/RX can be achieved.

As previously discussed, wireless carriers want to support UAVs on their networks, and 3GPP has a work item on enhancing UAV support. Study and measurements show that UAVs cause excessive interference to the ground base stations and suffer severe interference from many BSs. Directional TX/RX has been shown to mitigate the interference issues significantly and can be potentially implemented as a proprietary solution without introducing new specification changes. The directional beam can be formed based on directional antenna or MIMO beamforming. Beamforming using an antenna array is sometimes referred to as multiple input multiple output (MIMO) beam forming.

Yet there are problems. Typically, a UE uses an omni-directional antenna. Applying a directional pattern/beam emphasizes one particular direction while suppressing others. As a UAV moves through the network, it may benefit from steering its beam, mechanically or electrically, from one cell to another for best signal quality. Measurement on the baseband is impacted by the directional pattern and may create issues for cell quality measurement or hand-over. When the beam is not pointed correctly, it may enhance interference while suppressing useful signals. This is more pronounced when a UAV is equipped with one directional antenna that is mechanically tilted from one cell to another.

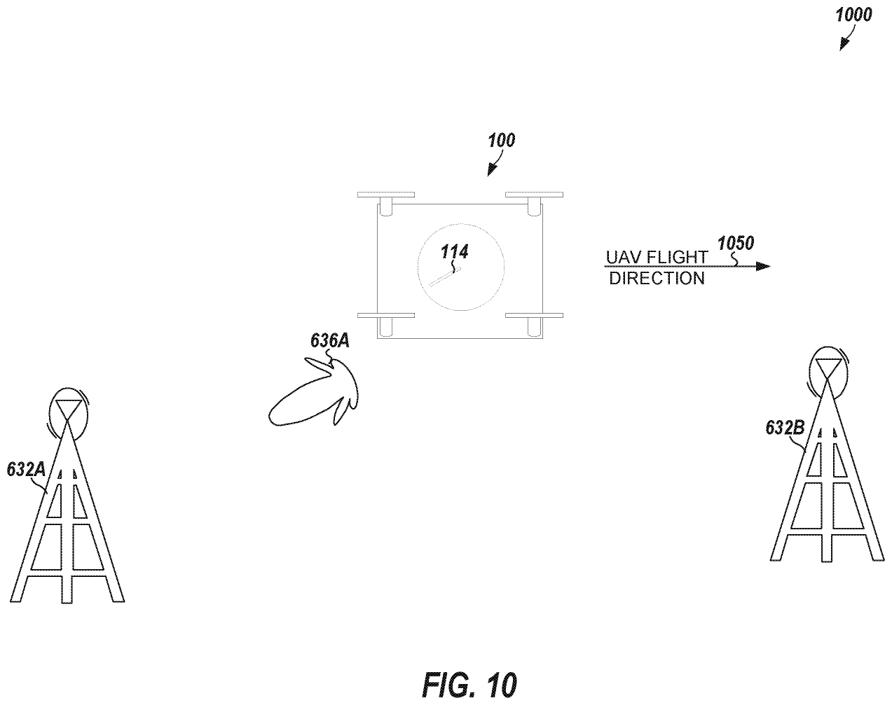

FIG. 10 illustrates, by way of example, a diagram of an aspect of a system 1000 that illustrates this problem. The system 1000 as illustrated includes the UAV 100 communicating with a first base station 632A of the communications network and flying towards a second base station 632B of the communication network as indicated by the fly direction 1050. As the UAV 100 gets closer to the base station 632B, it can be advantageous for the UAV 100 to direct the transmission pattern 636A of the antenna 114 towards the base station 632B. This can help ensure better signal quality for communications between the UAV 100 and the base station 632B.

Another problem with directional antennas in UAVs can include, when using MIMO to form beams, the number of antennas is limited by the low frequency band. For an LTE band, one cannot generally have more than 3-4 antennas with a half-lambda separation. And the pattern will not be sharp. When using a single directional antenna, then one has to mechanically tilt it to different directions when needed. Considering that a half lambda antenna size for a 2 GHz wave is around 7-8 cm. A typical commercial drone can not have very many 7-8 cm antennas on board due to size constraints. This is in comparison to a mmWave antenna where half lambda antenna size is on a millimeter scale. Because of this limit, it can be difficult to generate a sharp beam every few degrees. A special antenna with a directional pattern can be generated, but mechanical tilting the antenna to change direction takes time.

In aspects, one or more problems of UAV operation on a communications network are solved so that a UAV with a directional TX/RX operates on the communications network (e.g., on a current LTE network). One example to aid understanding includes when the drone modem of the circuitry is working with only one or two antenna ports.

Use of a directional TX/RX that is transparent to an existing baseband is new for a UAV on a cellular network. For the problem of cell switching, an independent omni-directional TX/RX antenna can be used in parallel to the directional TX/RX formed by directional antenna(s) or MIMO. The directional antenna and omni-directional antenna can be connected to different antenna ports. In TX/RX, diversity or maximum-ratio combining (MRC)/MIMO between the two ports can be applied. For overcoming the antenna limitation of MIMO, multiple directional antennas can be put on a UAV. The directional antennas can be switched on/off based on a particular direction needed to communicate to a base station. The direction can be based on knowledge of the network as stored in the database.

These aspects provide benefits of directional TX/RX in mitigating interference, while avoiding issues in transition from one cell to another (e.g., wrong pointing, abrupt or slow beam transition, or the like). Aspects can operate with existing or future cellular networks without requiring a change to the standard. To support directional TX/RX, the following aspects can be used: (1) Equip each UAV with one independent antenna with omni-directional pattern. Connect it to an antenna port, Port 1; and (2A) Equip each drone with one or more directional antennas and connect the directional antennas to a different antenna port, port 2, or (2B) equip each UAV with an antenna array which can form beams, and connect to a different antenna port, Port 2.

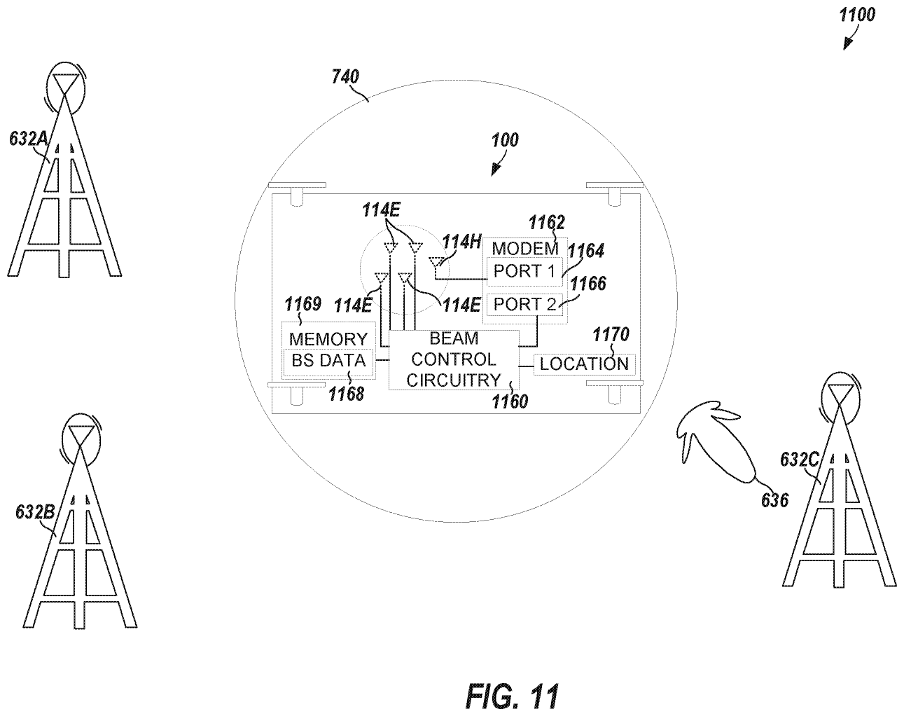

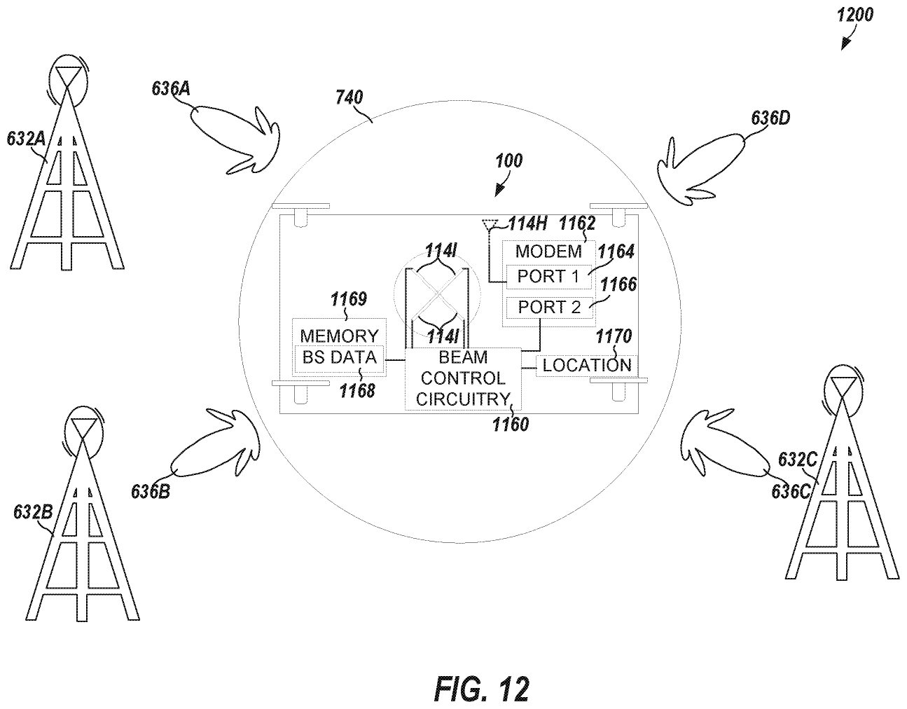

FIGS. 11 and 12 illustrate, by way of example, respective diagrams of aspects of systems 1100 and 1200 for UAV communication over a communications network. The systems 1100 and 1200 as illustrated include the UAV 100 and some base stations 632A, 632B, 632C. The UAV 100 of FIGS. 11 and 12 include a modem 1162 with two ports 1164, 1166, beam control circuitry 1160, and memory 1169 with base station (BS) data 1168, and location circuitry 1170. The UAV 100 of FIG. 11 as illustrated includes some omnidirectional antennas 114E in an array and a dedicated omni-directional antenna 114H. The UAV 100 of FIG. 12 as illustrated includes some directional antennas 114I and the dedicated omni-directional antenna 114H. The directional antennas 114I can provide directed transmission patterns 636A-636D to provide transmissions that can be incident on the base station 632A-632C in any horizontal direction from the UAV 100, such as to have 360 degrees of coverage.

The modem 1162 includes circuitry for transmitting and receiving signals from and by the antennas 114E, 114H. The modem 1162 can include one or more modulators, demodulators, amplifiers, oscillators, phase shifters, time delay elements, mixers, power dividers, phase locked loops, or the like.

The ports 1164, 1166 can be coupled to respective antennas 114H or the beam control circuitry 1160. The beam control circuitry 1160 can control a phase, time, or the like of signals generated by the antennas 114E. The beam control circuitry 1160 can consult the BS data 1168 and determine, based on the BS data 1168, a direction to which to direct a beam, such as by using the antennas 114E of an array or the directional antenna(s) 114I. Through this control, the beam control circuitry 1160 can alter a direction of the transmission from the antennas 114E.

The BS data 1168 can indicate base stations 632A-632C and their corresponding locations. The location circuitry 1170 can indicate a current location of the UAV 100. The location circuitry 1170 can operate using a global positioning system (GPS), Galileo system, triangulation, time of flight of a signal to/from a device at a known location, or the like. The location circuitry 1170 can determine an orientation of the UAV 100. The orientation can be determined using an accelerometer, gyroscope, compass, or the like. The beam control circuitry 1160 can determine an orientation of a directional antenna 114I that is movable, a direction to which to point an antenna array beam, or which directional antenna(s) 114I to power on to transmit signals to a nearest or best base station 632A-632C. The beam control circuitry 1160 can make this determination based on the location provided by the location circuitry 1170 and the BS data 1168.

FIG. 11 illustrates an example transmission pattern 636 of the antennas 114E. An example transmission pattern 740 of the omni-directional antenna 114H is also provided. Alternative to the antennas 114E organized in an array, the UAV 100 can include one or more directional antennas 114I, such as shown in FIG. 12.

The systems 1100 solve one or more of the problems with including a directional transmission (e.g., from a directional antenna or an antenna array) in a UAV. Whether the directional beam (from the directional antenna or MIMO) points correctly, wrong or is transitioning from one cell to another, the antenna 114H coupled to the antenna port 1164, using the omni-directional transmission pattern 740, can compensate for at least some signal quality changes. For example, if the beam from the antenna(s) on the port 1166 are pointing to a wrong direction without the omni-directional antenna 114H, then the wanted signal is suppressed while unwanted is boosted, leading to broken or weak link. With the omni-directional antenna 114H on, diversity or MRC/MIMO operation can automatically compensate for loss. When a UAV slowly tilts its directional transmission pattern 636 from one cell to another, the omnidirectional antenna 114H can smooth out the cell quality fluctuation when only a directional antenna is used.

The systems 1100 and 1200 can reduce interference between transmissions to/from the UAV 100 and other devices. The systems 1100 and 1200 can reduce the interference by using directional transmissions. The directional transmissions can be made narrower or more accurate by increased accuracy in the location determined by the location circuitry 1170 and stored in the BS data 1168. Further, the beam control circuitry can change the beam pointing quickly. With a specially designed panel antenna for narrow bandwidth, one can make the antenna 114 very small and cheap. Note that one can sacrifice antenna efficiency compared to a design for mobile phones. Compared to the rotors of the UAV 100 (the components that spin the propellers of the UAV 100), the communication subsystem consumes only a small portion of the total power. A typical commercial UAV can operate at 100-200 Watt for about 30 minutes. The communication subsystem (e.g., such as can include the antennas 114, modern 1162, location circuitry 1170, beam control circuitry 1160, or the memory 1169) can consume only a small portion of that total power.

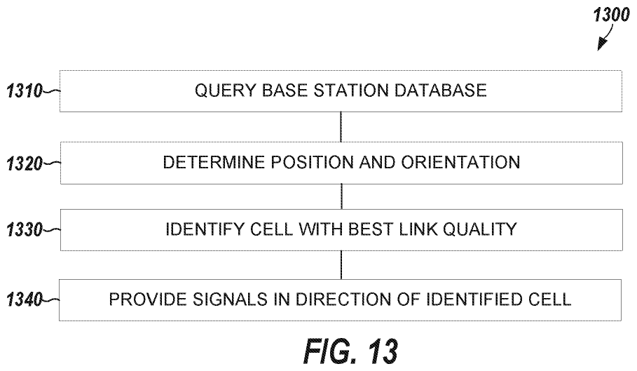

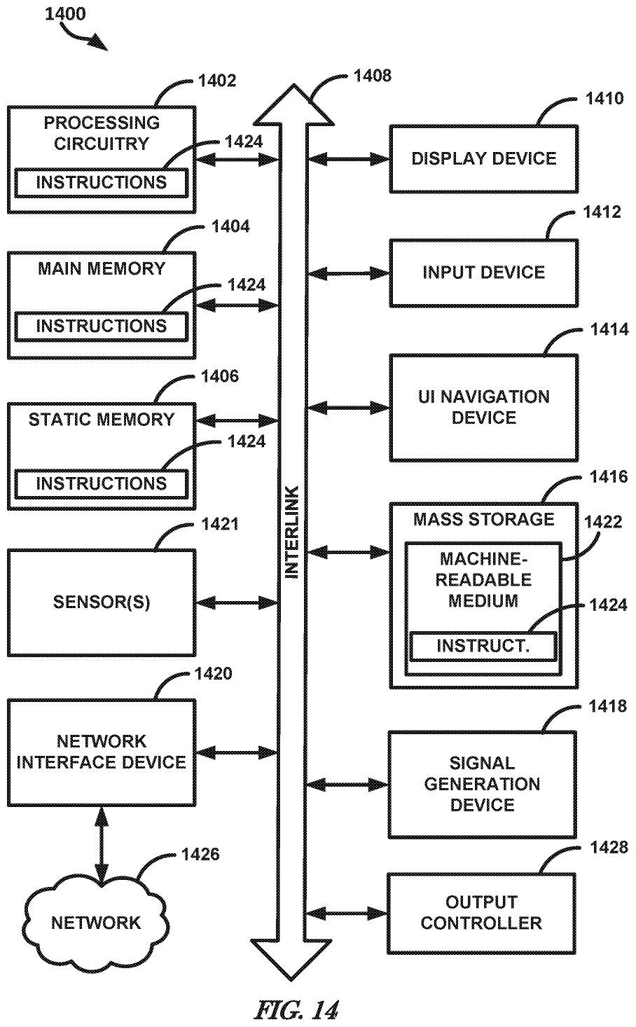

FIG. 13 illustrates, by way of example, a diagram of an aspect of a method 1300 for UAV communication in a communications network. The method 1300 as illustrated includes querying the BS data 1168, at operation 1310; determining a position and orientation of the UAV 100 (e.g., using the location circuitry 1170), at operation 1320; identifying a cell with the best link quality (e.g., without considering beam direction required from the UAV 100), at operation 1330; and providing signals in the direction of the identified cell (e.g., using the beam control circuitry 1160), at operation 1340. The operation 1340 can include pointing a beam from the antenna(s) coupled to the port 1166 towards the identified cell. In aspects in which the UAV 100 includes multiple directional antennas 1141, the antennas 1141 that are not needed to transmit in the determined direction can be powered off.

FIG. 14 illustrates a block diagram of an example machine 1400 upon which any one or more of the techniques (e.g., methodologies) discussed herein may perform. In alternative aspects, the machine 1400 may operate as a standalone device or may be connected (e.g., networked) to other machines. In a networked deployment, the machine 1400 may operate in the capacity of a server machine, a client machine, or both in server-client network environments. In an example, the machine 1400 may act as a peer machine in peer-to-peer (P2P) (or other distributed) network environment. The machine 1400 may be, or be a part of, an Autonomous Vehicle, a communications network device, a cloud service, a personal computer (PC), a tablet PC, a personal digital assistant (PDA), a mobile telephone, a smart phone, or any machine capable of executing instructions (sequential or otherwise) that specify actions to be taken by that machine. For example, machine 1400 may be or be part of the circuitry on the circuit board 108, housed in the body 107 of the UAV 100, or the base station 632A-632C. One or more items of the UAV 100 or the base station 632A-632C, such as the beam control circuitry 1160, location circuitry 1170, modem 1162, or other item of the UAV 100, or the system 600, 700, 800, 1000, 1100, or 1200 can include one or more components of the machine 1400. In some aspects, the machine 1400 may be configured to implement a portion of the methods 900 and 1300 discussed herein. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part, or all, of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a module at one instance of time and to constitute a different module at a different instance of time.

Machine (e.g., computer system) 1400 may include a hardware processing circuitry 1402 (e.g., a central processing unit (CPU), a graphics processing unit (GPU), a hardware processor core, or any combination thereof), a main memory 1404 and a static memory 1406, some or all of which may communicate with each other via an interlink (e.g., bus) 1408. The machine 1400 may further include a display unit 1410, an alphanumeric input device 1412 (e.g., a keyboard), and a user interface (UI) navigation device 1414 (e.g., a mouse). In an example, the display unit 1410, input device 1412 and UI navigation device 1414 may be a touch screen display. The machine 1400 may additionally include a storage device (e.g., drive unit) 1416, a signal generation device 1418 (e.g., a speaker), a network interface device 1420, and one or more sensors 1421, such as a global positioning system (GPS) sensor, compass, accelerometer, or other sensor. The machine 1400 may include an output controller 1428, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 1416 may include a machine readable medium 1422 on which is stored one or more sets of data structures or instructions 1424 (e.g., software) embodying or utilized by any one or more of the techniques or functions described herein. The instructions 1424 may also reside, completely or at least partially, within the main memory 1404, within static memory 1406, or within the hardware processing circuitry 1402 during execution thereof by the machine 1400. In an example, one or any combination of the hardware processing circuitry 1402, the main memory 1404, the static memory 1406, or the storage device 1416 may constitute machine readable media.

While the machine readable medium 1422 is illustrated as a single medium, the term “machine readable medium” may include a single medium or multiple media (e.g., a centralized or distributed database, and/or associated caches and servers) configured to store the one or more instructions 1424.

The term “machine readable medium” may include any medium that is capable of storing, encoding, or carrying instructions for execution by the machine 1400 and that cause the machine 1400 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 1424 may further be transmitted or received over a communications network 1426 using a transmission medium via the network interface device 1420. The machine 1400 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 1420 may include one or more physical jacks (e.g., Ethernet, coaxial, or phone jacks) or one or more antennas to connect to the communications network 1426. In an example, the network interface device 1420 may include a plurality of antennas to wirelessly communicate using at least one of single-input multiple-output (SIMO), multiple-input multiple-output (MIMO), or multiple-input single-output (MISO) techniques. In some examples, the network interface device 1420 may wirelessly communicate using Multiple User MIMO techniques.

### Other Notes and Examples

Example 1 includes an unmanned aerial vehicle (UAV) comprising a modem comprising a first antenna port and a second antenna port, an omnidirectional antenna connected to the first antenna port, and antennas configured to generate a directional transmission pattern connected to the second antenna port, the antennas including (a) an array of omni-directional antennas and (b) multiple directional antennas.

In Example 2, Example 1 can further include beam control circuitry to provide control signals to the antennas to control a direction of the directional transmission pattern.

In Example 3, Example 2 can further include a memory including data indicating locations of respective base stations of a communications network through which the UAV modem is configured to communicate.

In Example 4, Example 3 can further include location circuitry to determine a location of the UAV and wherein the beam control circuitry is to control the direction of the directional transmission pattern based on the determined location and a location of the locations in the memory.

In Example 5, Example 4 can further include, wherein the location circuitry is further to determine an orientation of the UAV, and the beam control circuitry is to control the direction of the directional transmission pattern further based on the determined orientation of the UAV.

In Example 6, at least one of Examples 4-5 can further include, wherein the beam control circuitry is to power off one or more antennas of the antennas that are not used to form the directional transmission pattern.

In Example 7, at least one of Examples 1-6 can further include, wherein the antennas include directional antennas attached to a circuit board and situated with about a uniform angular separation between directly adjacent antennas.

In Example 8, Example 7 can further include, wherein the antennas are attached to a ground plane of the circuit board.

In Example 9, at least one of Examples 7-8 can further include, wherein the antennas are situated in an antenna module that is connected to an underside of the UAV that faces a surface of the earth when the UAV is in flight or a topside of the UAV that faces away from the surface of the Earth when the UAV is in flight.

In Example 10, at least one of Examples 7-9 can further include, wherein the directional antennas include three or more directional antennas.

In Example 11, at least one of Examples 2-10 can further include, wherein the beam control circuitry is further configured to power on the omnidirectional antenna to scan for signals from base stations of a communications network.

In Example 12, Example 11 can further include control circuitry configured to generate data to be included in a report to the base stations.

In Example 13, Example 12 can further include, wherein the control circuitry is further configured to alter the data based on antennas to be used to communicate with a base station of the base stations in a directional transmission.

Example 14 includes a method for communication between a base station of a communications network and an unmanned aerial vehicle (UAV), the method comprising receiving, at a first antenna port of the UAV to which an omnidirectional antenna is coupled, signals from the base station, generating, by circuitry of the UAV, a report indicating a link quality of transmissions between the base station and the UAV, transmitting, by the omnidirectional antenna, the report to the base station, and transmitting, using a directional transmission pattern generated by one or more antennas coupled to a second antenna port of the UAV, encoded signals to the base station.

In Example 15, Example 14 can further include, wherein the one or more antennas coupled to the second antenna port include (a) an array of omni-directional antennas or (b) one or more directional antennas.

In Example 16, at least one of Examples 14-15 can further include providing, by beam control circuitry of the UAV, control signals to the one or more antennas coupled to the second antenna port to control a direction of the directional transmission pattern.

In Example 17, Example 16 can further include identifying, by a memory of the UAV including data indicating locations of respective base stations of a communications network through which a UAV modem is configured to communicate, the base station.

In Example 18, Example 17 can further include determining, by location circuitry of the UAV, a location of the UAV, and controlling, by the beam control circuitry, the direction of the directional transmission pattern based on the determined location and a location of the locations in the memory.

In Example 19, Example 18 can further include determining, by the location circuitry, an orientation of the UAV, and wherein controlling, by the beam control circuitry, the direction of the directional transmission pattern includes controlling the direction based on the determined orientation of the UAV.

In Example 20, at least one of Examples 18-19 can further include powering off, by the beam control circuitry, one or more antennas of the antennas that are not used to form the directional transmission pattern.

In Example 21, at least one of Examples 14-20 can further include, wherein the antennas include directional antennas attached to a circuit board and situated with about a uniform angular separation between directly adjacent antennas.

In Example 22, Example 21 can further include, wherein the antennas are attached to a ground plane of the circuit board.

In Example 23, Example 22 can further include, wherein the antennas are situated in an antenna module that is connected to an underside of the UAV that faces the Earth when the UAV is in flight or a top of the UAV that faces away from the Earth when the UAV is in flight.

In Example 24, at least one of Examples 22-23 can further include, wherein the directional antennas include three or more directional antennas.

Example 25 includes a non-transitory machine-readable medium including instructions that, when executed by unmanned aerial vehicle (UAV) circuitry, cause the UAV circuitry to perform the method of one of claims 14-24.

1. An unmanned aerial vehicle (UAV) comprising:
a modem comprising a first antenna port and a second antenna port;
an omnidirectional antenna connected to the first antenna port; and
antennas configured to generate a directional transmission pattern connected to the second antenna port, the antennas including (a) an array of omni-directional antennas and (b) multiple directional antennas.

2. The UAV of claim 1, further comprising beam control circuitry to provide control signals to the antennas to control a direction of the directional transmission pattern.

3. The UAV of claim 2, further comprising a memory including data indicating locations of respective base stations of a communications network through which the UAV modem is configured to communicate.

4. The UAV of claim 3, further comprising location circuitry to determine one or more of:
a location of the UAV; or an orientation of the UAV;
wherein the beam control circuitry is configured to control the direction of the directional transmission pattern based on one or more of:
the determined location and a location of the locations in the memory; or
the determined orientation of the UAV.

5. (canceled)

6. The UAV of claim 4, wherein the beam control circuitry is to power off one or more antennas of the antennas that are not used to form the directional transmission pattern.

7. The UAV of claim 1, wherein the antennas include directional antennas attached to a circuit board and situated with about a uniform angular separation between directly adjacent antennas.

8. (canceled)

9. The UAV of claim 7, wherein the antennas are situated in an antenna module that is connected to an underside of the UAV that faces a surface of the earth when the UAV is in flight or a topside of the UAV that faces away from the surface of the Earth when the UAV is in flight.

10. (canceled)

11. The UAV of claim 2, wherein the beam control circuitry is further configured to power on the omnidirectional antenna to scan for signals from base stations of a communications network.

12. The UAV of claim 11, further comprising control circuitry configured to generate data to be included in a report to the base stations.

13. The UAV of claim 12, wherein the control circuitry is further configured to alter the data based on antennas to be used to communicate with a base station of the base stations in a directional transmission.

14. A method for communication between a base station of a communications network and an unmanned aerial vehicle (UAV), the method comprising:
receiving, at a first antenna port of the UAV to which an omnidirectional antenna is coupled, signals from the base station;
generating, by circuitry of the UAV, a report indicating a link quality of transmissions between the base station and the UAV;
transmitting, by the omnidirectional antenna, the report to the base station; and
transmitting, using a directional transmission pattern generated by one or more antennas coupled to a second antenna port of the UAV, encoded signals to the base station.

15. The method of claim 14, wherein the one or more antennas coupled to the second antenna port include (a) an array of omni-directional antennas or (b) one or more directional antennas.

16. The method of claim 14, further comprising providing, by beam control circuitry of the UAV, control signals to the one or more antennas coupled to the second antenna port to control a direction of the directional transmission pattern.

17. The method of claim 16, further comprising identifying, by a memory of the UAV including data indicating locations of respective base stations of a communications network through which a UAV modem is configured to communicate, the base station.

18. The method of claim 17, further comprising:
determining, by location circuitry of the UAV, a location of the UAV; and
controlling, by the beam control circuitry, the direction of the directional transmission pattern based on the determined location and a location of the 25 locations in the memory.

19. The method of claim 18, further comprising:
determining, by the location circuitry, an orientation of the UAV; and
wherein controlling, by the beam control circuitry, the direction of the directional transmission pattern includes controlling the direction based on the determined orientation of the UAV.

20. (canceled)

21. The method of claim 14, wherein the antennas include directional antennas attached to a circuit board and situated with about a uniform angular separation between directly adjacent antennas.

22. (canceled)

23. The method of claim 21, wherein the antennas are situated in an antenna module that is connected to an underside of the UAV that faces the Earth when the UAV is in flight or a top of the UAV that faces away from the Earth when the UA V is in flight.

24. The method of claim 21, wherein the directional antennas include three or more directional antennas.

25. A non-transitory machine-readable medium including instructions that, when executed by unmanned aerial vehicle (UAV), cause the UAV to:
receive, at a first antenna port of the UAV to which an omnidirectional antenna is coupled, signals from a base station;
generate, by circuitry of the UAV, a report indicating a link quality of transmissions between the base station and the UAV;
transmit, by the omnidirectional antenna, the report to the base station; and
transmit, using a directional transmission pattern generated by one or more antennas coupled to a second antenna port of the UAV, encoded signals to the base station.
